(19) United States
(12) Patent Application Publication
(10) Pub. No.: US 2013/0294272 A1
(43) Pub. Date: Nov. 7, 2013

(54) DEACTIVATION OF MICRO CELLS IN CELLULAR WIRELESS NETWORKS

(71) Applicant: FUJITSU LIMITED, Kawasaki-shi (JP)

(72) Inventors: Hui Xiao, West Drayton Middlesex (GB); Rajaguru Mudiyanselage Mythri Hunukumbure, Hillingdon (GB)

(73) Assignee: FUJITSU LIMITED, Kawasaki-shi (JP)

(21) Appl. No.: 13/886,022

(22) Filed: May 2, 2013

(30) Foreign Application Priority Data
May 2, 2012 (GB) 1207648.5

(51) Int. Cl. H04W 52/02

(52) U.S. Cl. CPC H04W 52/0206
USPC 370/252

(57) ABSTRACT

A cell ranking algorithm for power saving in a cellular wireless network having a heterogeneous network structure of macro and micro cells. The algorithm determines when and which micro cells in the network can be deactivated, by which the power consumption of the network can be reduced. A micro cell (Micro d) having a traffic load below a threshold value is deactivated and its load is assigned to adjacent macro cells (Macro a, Macro b) acting as compensation cells. The proposed algorithm is based on the comprehensive consideration of factors that have influence on the power saving of the network and the balance between the traffic load (or quality of service) and the energy saving.

### FIELD OF THE INVENTION

The present invention relates to cellular wireless networks, more particularly to heterogeneous networks (HetNets).

### BACKGROUND OF THE INVENTION

The global information and communication technology (ICT) industry is a fast growing contributor to worldwide greenhouse gas emissions. According to 2008 figures, it was estimated that 3 percent of worldwide energy consumption was caused by the ICT infrastructure that generated about 2 percent of worldwide CO₂ emissions. Optimizing the energy efficiency of wireless communications not only reduces environment impact, but also cuts overall network costs and helps make communication more practical and affordable in a pervasive setting.

Cellular wireless networks are widely known in which base stations (BSs) communicate with user equipments (UEs) (also called terminals, or subscriber or mobile stations) within range of the BSs.

The geographical areas covered by base stations are generally referred to as cells, and typically many BSs are provided in appropriate locations so as to form a network or system covering a wide geographical area more or less seamlessly with adjacent and/or overlapping cells. (In this specification, the terms “system” and “network” are used synonymously except where the context requires otherwise). In each cell, the available bandwidth is divided into individual resource allocations for the user equipments which it serves. The user equipments are generally mobile and therefore may move among the cells, prompting a need for handovers between the base stations of adjacent and/or overlapping cells. A user equipment may be in range of (i.e. able to detect signals from) several cells at the same time, and it is possible for one cell to be wholly contained within a larger cell.

It is widely assumed that future cellular wireless networks will adopt the structure of the so-called heterogeneous network, composed of two or more different kinds of cells. At least one kind of cell provides basic network coverage to all users within the area covered by the network. These are referred to as “basic coverage cells” in the claims and summary of the invention. For convenience, below and in the detailed description, reference is made to “macro” cells as one possible kind of basic coverage cell.

Smaller cells, overlapping in coverage with the basic coverage cells but using different frequencies, provide additional capacity to users particularly within so-called “hot spot zones”. These are referred to as “additional capacity cells” in the claims and summary of the invention. For convenience, below and in the detailed description, reference is made to “micro” cells as one possible kind of additional capacity cell. However, no limitation is to be construed from the use of the labels “macro” and “micro”.

FIG. 1 depicts a simple heterogeneous network. The big circles 10, 12 labelled Cell A and Cell B, and small circles labelled Cell C through Cell G represent the macro and micro cells in the network respectively.

The radio access technology (RAT) adopted by these cells could be any kind, for example, 3G or 4G. Here it is assumed that a 4G RAT such as LTE is adopted by each of the cells in the network, and LTE is used as an example to illustrate the proposed method. Although only two types of cell, macro or micro, are shown in FIG. 1, various levels of cell are under consideration for 4G including so-called femto and pico cells. Femto and pico cells can be overlaid on either macro or micro cells; consequently, the big circles 10, 12 could in actuality be micro cells providing basic coverage, with additional capacity provided by femto or pico cells. Also, in LTE each base station (called eNB in LTE) generally is sectorized into N (N>=1) partitions, each of which or any subset of which may constitute a cell. A typical example is for the base station to have three sectors, each of which is configured as a cell with frequency reuse factor being 1. Therefore, references to “cell” therefore include “ sector” unless where the context demands otherwise.

The area depicted in FIG. 1 could be as small as, say, a single office building, but will be referred to as a “geographical area” for convenience. For example in FIG. 1, the dashed circles depict two hot spot zones 50 and 52 and the higher demand on capacity from users in these zones are satisfied by using the micro cells C, D and E, F, G respectively.

The demands of users in, for example, making voice calls, downloading files and so forth give rise to a traffic load in each geographical area of the network, and on each micro and macro cell. Imagining the deployment area in FIG. 1 is a business district in a town, the temporal traffic load variation in 24 hours is exemplified by FIG. 2.

In FIG. 2, the horizontal axis represents time in units of hours through one day, based on local time in the area being considered. The vertical axis shows traffic load, which is normalized with respect to the load at the peak hour. There are various reasons for the variation of traffic load in a certain area; for example, the migration of users from the business district to residential districts or transportation lines, or the significant reduction in the number of active users from day time to night time. It is assumed that the macro cells are always on (activated) in order to provide at least basic network coverage. However, with the general reduction in traffic load in a certain area, during some time periods the micro cells for capacity boosting purposes can be deactivated and their traffic loads offloaded to the neighbouring macro cells (“neighbouring” macro cells being those within range of at least some users in a micro cell).

FIG. 3 Illustrates compensation by macro cells. Here, each BS (BS1, BS2, BS3 and BS4) has three cells. A micro cell d has three neighboring macro cells (macro a, macro b and macro c) belonging to BS1, BS2 and BS3 respectively. If micro cell d is deactivated, then its coverage can be compensated by using these three macro cells. The arrows in FIG. 3 point to the respective coverage areas of the compensation macro cells in micro cell d. As indicated by dots in FIG. 3, the users UE currently being served by the micro cell d may be assigned to one of the macro cells, allowing micro cell d to be deactivated. The initial intention is to assign users in different compensation partitions (which are based on the coverage partitions to be taken care of by different compensation cells) to their respective coverage compensation cells. However, depending on different macro cells' compensation capabilities in capacity, the compensation macro cells' coverage boundaries in micro cell d may be redrawn to balance the traffic load distribution in different compensation macro cells.

Thus the energy consumption of the network can be reduced and the energy efficiency can be improved.

However, it is critical to determine when the suitable time for the micro cell (additional capacity cell) to be deactivated is, and when there are multiple micro cells that have low traffic loads, which ones should have the priorities to be deactivated.

There is consequently a need for a method of managing a heterogeneous network which allows deactivation of additional capacity cells where appropriate to save electrical power, whilst maintaining users' quality of service as far as possible.

### SUMMARY OF THE INVENTION

According to a first aspect of the present invention, there is provided a method of managing power consumption in a heterogeneous network, the heterogeneous network providing cells for wireless communication including basic coverage cells and additional capacity cells overlapping with the basic coverage cells, the method comprising:
(i) determining traffic loads on the basic coverage cells and additional capacity cells;
(ii) triggering an analysis process when the load on at least one cell meets a threshold condition;
(iii) if an additional capacity cell meets the threshold condition, seeking one or more basic coverage cells as a compensation cell to take over the load on that additional capacity cell; and/or
(iv) if a basic coverage cell meets the threshold condition, seeking at least one additional capacity cell from which the basic coverage cell can take over the load as a compensation cell;
(v) marking for deactivation an additional capacity cell considered in step (iii) and for which at least one compensation cell has been found and/or marking for deactivation an additional capacity cell found in step (iv), and
(vi) deactivating any additional capacity cell marked for deactivation and instructing at least one compensation cell to take over the load from the additional capacity cell.

Preferably, step (i) includes collecting current cell load information of active basic coverage and additional capacity cells, analysing the collected information to generate a predicted traffic map in an investigation area of the network, and estimating the traffic load on each of the cells in the investigation area.

Preferably, step (ii) includes triggering an analysis process based on the predicted cell load of cells in the investigation area.

Preferably, step (iii) comprises obtaining a list of basic coverage cells for possible use as compensation cells.

Preferably, step (iii) and/or step (iv) comprises or is followed by compiling a prioritized list of additional capacity cells considered for deactivation, and step (v) comprises marking for deactivation at least one additional capacity cell on the basis of the prioritized list. Here, the prioritized list may rank candidate additional capacity cells based at least partly on a power saving gain, or based at least partly on a resource efficiency criterion, or based on a weighted sum of a power saving gain and a resource efficiency criterion. The prioritized list may be a combined list from steps (iii) and (iv); that is, the step (iii) and step (iv) micro candidate cells can be used to form a combined micro candidate cell list, which is used to compile a combined prioritized list for the deactivation.

The power saving gain referred to above is preferably determined by calculating a difference between a power consumption for operating the additional capacity cell and the “idle” power consumption when the additional capacity cell is deactivated.

The resource efficiency criterion referred to above may quantify basic coverage cell resources offered to take over the load on the additional capacity cell, relative to the basic coverage cell resources required to meet the additional capacity cell's load.

Here, the required basic coverage cell resources are preferably estimated based on long-term SNR/SINR distributions provided by transmitters of one or more basic coverage cells to one or more regions covered by the additional capacity cell.

After marking an additional capacity cell for deactivation in step (v), the prioritized list referred to above may be recompiled, taking into account the effect on one or more compensation cells of taking over the additional capacity cell's load.

The method may further comprise determining a resource efficiency criterion for the basic coverage cells and redistributing load among basic coverage cells to avoid overloading a compensation cell.

In any method as defined above, preferably, the threshold condition is met when a current traffic load or a predicted traffic load on a cell falls below a threshold value.

Power consumption for operating an additional capacity cell may be determined by predicting a future traffic load on the cell. Likewise, the basic coverage cell resources needed to calculate the resource efficiency criterion may be determined by predicting a future traffic load on the cell.

In any method as defined above, preferably, the deactivation of a cell remains valid for a predetermined time interval, after which the method is repeated to permit reactivation of a deactivated additional capacity cell.

The methods defined above may be applied to a self-organizing network, SON, wherein the method is carried out by a SON server of the network.

Thus, according to a second aspect of the present invention, there is provided a SON server arranged to carry out any method as defined above.

According to a third aspect of the present invention, there is provided software which, when executed by a processor of a SON server, performs any method as defined above. Such software may be recorded on a computer-readable medium.

Embodiments of the present invention provide an energy saving method using deactivation of some of the transmission cells at off-peak hours, within a heterogeneous network composed of basic coverage cells and additional capacity cells, henceforth referred to for simplicity as macro and micro cells respectively. During off-peak traffic hours, the traffic loads of micro cells and/or macro cells can be significantly reduced compared to those at peak hours; for example, traffic tends to be much lower at night.

Thus it is possible to deactivate certain active transmission cells, and to use the neighbouring cells of the deactivated cells as compensation cells during off-peak hours. Since deactivating some of the transmission cells to save energy should not cause any coverage hole problems to the network, it is sensible to deactivate the micro cells in preference to macro cells, and to use macro cells to compensate for the coverage and capacity of deactivated micro cells. Therefore, in the cases where there exist multiple micro cells whose traffic loads significantly reduce at off-peak hours and there is a limited number of compensation cells, or any of the micro cells whose traffic load becomes lower and lower from peak hours to off-peak hours could be deactivated at certain time point, there is a need to determine when and which micro cells should be deactivated wisely to balance the power saving gain and the quality of service (QoS) of UE.

Embodiments of the present invention provide a cell ranking algorithm to determine when the suitable time is to deactivate a micro cell at off-peak hours and to determine which micro cells should be prioritized for the deactivation based on the comprehensive consideration of factors that have influence on the network power saving and the balance between the traffic load (or QoS) and the energy saving.

By means of the present invention, it is possible to balance the QoS of users and the energy saving gain of the network when determining the suitable time for deactivation of a micro cell, and secondly the cell ranking algorithm provides an approach to determine which cells should be prioritized for the deactivation when there are multiple cells that have low traffic loads and there is a limited number of compensation cells.

### BRIEF DESCRIPTION OF THE DRAWINGS

Reference is made, by way of example only, to the accompanying drawings in which:

FIG. 1 illustrates a heterogeneous network;

FIG. 2 illustrates a temporal profile for wireless data traffic in a heterogeneous network;

FIG. 3 Illustrates compensation by macro cells;

FIG. 4 is an overall flowchart of a cell ranking algorithm employed in an embodiment of the present invention;

FIG. 5 is a flowchart of a deactivation process in FIG. 4;

FIG. 6 is a flowchart of analyzing process Case 1 in FIG. 4;

FIG. 7 The flowchart of analyzing process Case 2 in FIG. 4; and

FIG. 8 The flowchart of analyzing process Case 3 in FIG. 4.

### DETAILED DESCRIPTION

Nowadays, cellular operators try to optimize their network performance and maintain network functionalities with minimal human intervention, which can not only cut the operational costs but also improve service quality. This is the so-called self organising network (SON), and it is assumed that there is a SON server located somewhere in this kind of network collecting information from BSs, analyzing the information and instructing the BSs what actions should be taken in order to optimize the system performance against certain requirements.

In a 4G network based on LTE-A for example, the BSs are referred to as eNodeBs or eNBs. As already mentioned each eNodeB may be sectorized to N partitions and one cell can consist of one or multiple partitions. This allows a single eNodeB to provide multiple cells, each cell having its own corresponding radio equipment including a transmitter, which may be either activated (“on”) or deactivated (“off” or “sleep mode”). In the detailed description which follows, the terms “macro” and “micro” are not restricted to specific meanings assigned in any particular standard such as LTE. “Macro” cells are any cells providing basic network coverage, whilst the “micro” cells referred to above are any cells overlaid on the “macro” cells for the purpose of providing additional capacity.

In the subsequent description, references to a “cell” implies the relevant cell's eNodeB where appropriate. In particular, “switching off' or “deactivating” a micro cell means placing the corresponding radio equipment of an eNodeB in an “idle” or “sleep” mode, from which it may be reactivated at some later time. In the case of N=1, the eNodeB provides a single cell, so deactivating the cell is equivalent to deactivating the eNodeB as a whole. References to “users” below implies a user's terminal (UE) where necessary.

In order to enable the deactivation of micro cells at off-peak traffic hours, the SON server needs to collect the traffic load information from all eNodeBs in the considered area. The SON server monitors the traffic loads of all the cells in a certain investigation area that has one or more hot spot zones.

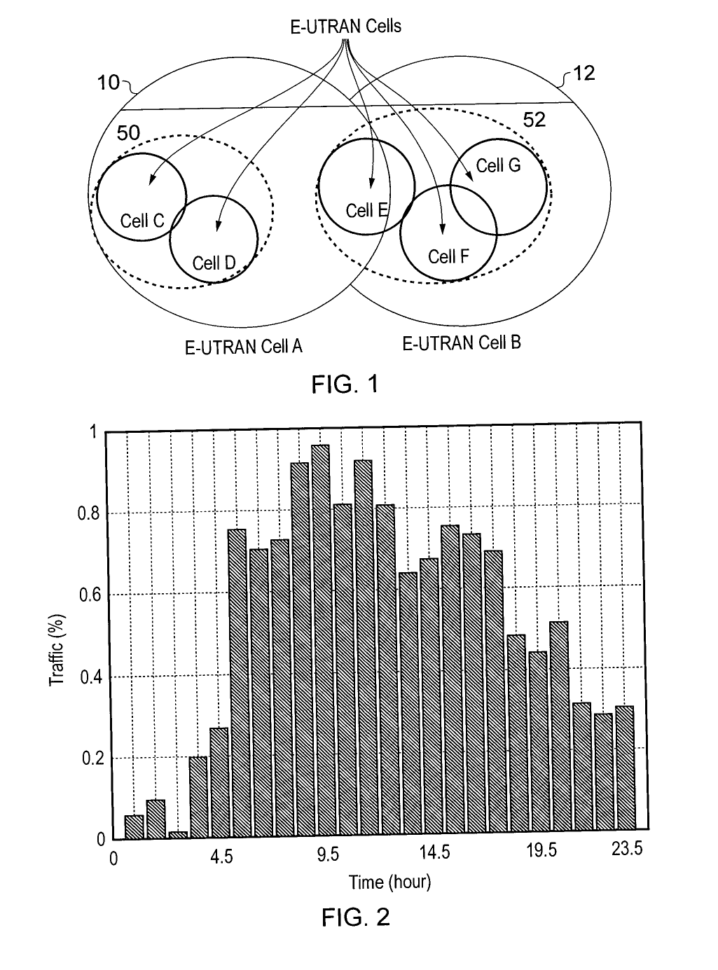

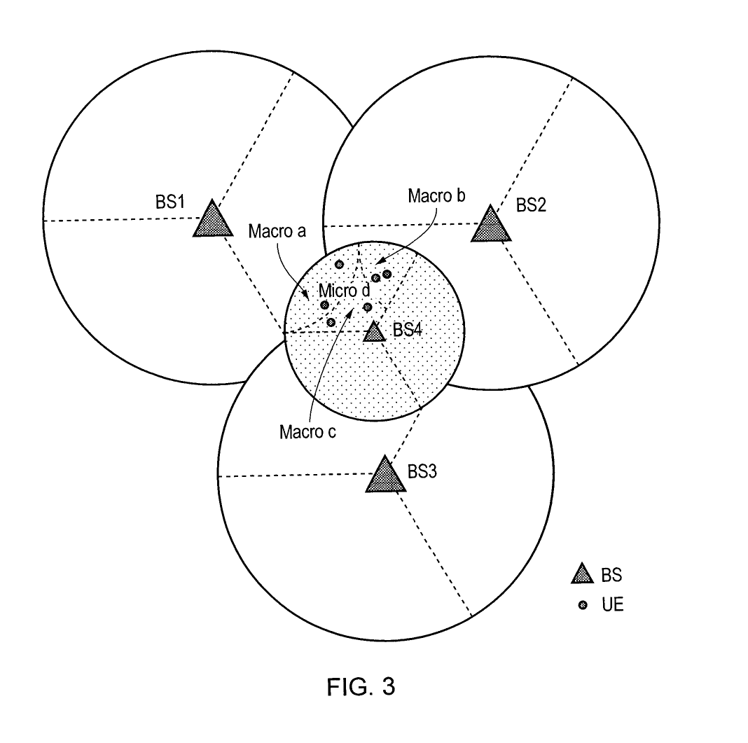

Here the “investigation area” refers to a generic area to which the deactivation ranking algorithm, described below, can be applied. This could in principle be the entire network under control of the SON server, but more typically will be a subset of the whole network. Of course, it would be possible for the SON server to apply the algorithm to multiple investigation areas in turn, so as to cover the whole network over time. Preferably, the investigation area can have at least one or more hot spot zones, because otherwise the deactivation algorithm has no candidate cells to work on. The size of the investigation area is configurable, for example, in the heterogeneous network of FIG. 1 it could be the same size or half of the size of the area depicted in the Figure. The area shown in FIG. 3 might be just one part of a larger investigation area considered by the algorithm.

The SON server can collect all cells' traffic loads of which it is in charge. This traffic may be either uplink or download traffic or (more usually) a mixture of both. In one embodiment, when the traffic load of any cell (micro/macro) meets a given threshold condition, for example is lower than a predefined threshold, the SON server triggers the analyzing process.

In another embodiment, the collected cell load information is used together with some existing traffic prediction method at the SON server to generate a traffic distribution map for the investigation area. Thereafter, the predicted traffic distribution map is used to estimate the traffic load on each of the cells in the investigation area. When the predicted traffic load of any cell (micro/macro) meets a given threshold condition, for example is lower than a predefined threshold, the SON server triggers the analyzing process.

In either case, the predefined threshold could be variable; for example, it can be configured by operators or calculated by some algorithm. The threshold may vary from one region or occasion to another, such as different values for different hot spot zones.

In another embodiment, the cell load information of different time periods are obtained from a database of the network operator's stored historical information, thus the predicted cell load of the next time period used to trigger the analyzing process is read from the database. This embodiment can be employed when the algorithm is applied to diagnosing the network's potential for energy saving using historical data provided by the operator.

The procedure carried out by the SON server will now be explained in more detail with reference to three Cases as follows.

Case 1: if the analyzing process is triggered by one micro cell that has traffic load lower than the threshold, then the SON server analyzes if the micro cell could be deactivated and seeks one or more neighbouring macro cells to be used as compensation cells. Here, compensation cells are macro cells that can provide coverage in the original micro cell's coverage area (the macro cells are also referred to as “underlay” cells). The compensation cells needs not lie within the investigation area.

Case 2: if the analyzing process is triggered by one macro cell whose traffic load is lower than the threshold, then the SON server checks if there are any micro cells that are under the coverage of this low load macro cell and if so calculates a priority list of micro cells to be deactivated and analyzes whose traffic loads can be accommodated by the macro cell.

Case 3: if the analyzing process is triggered by multiple cells (micro and/or macro) whose traffic loads are lower than the threshold, then the SON server calculates a priority list of micro cells to be deactivated and analyzes which ones can be turned to sleep mode in the next time period and what the corresponding compensation patterns are.

The “priority lists” referred to above can be combined into a single list. That is, micro cell candidates considered in both Case 2 and Case 3 can be used to form a combined micro cell candidate list, which is used to compile a combined prioritized list for the deactivation.

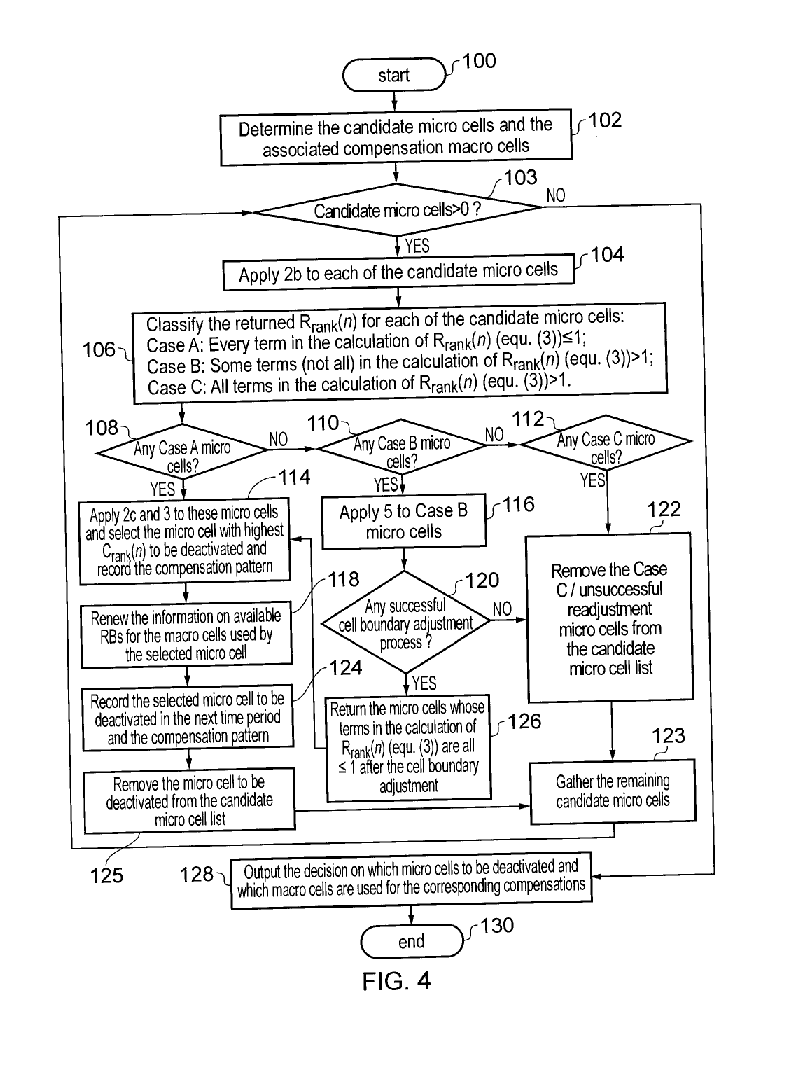

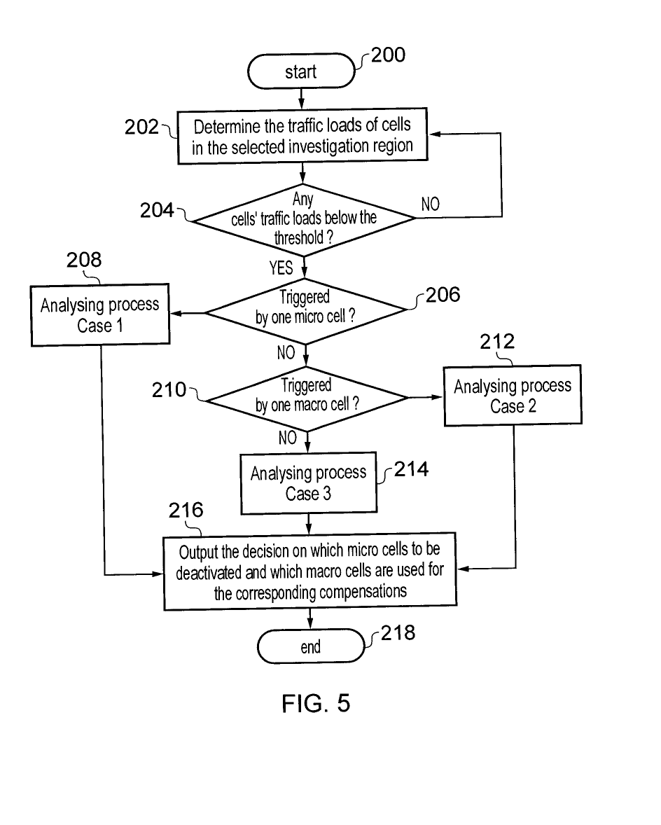

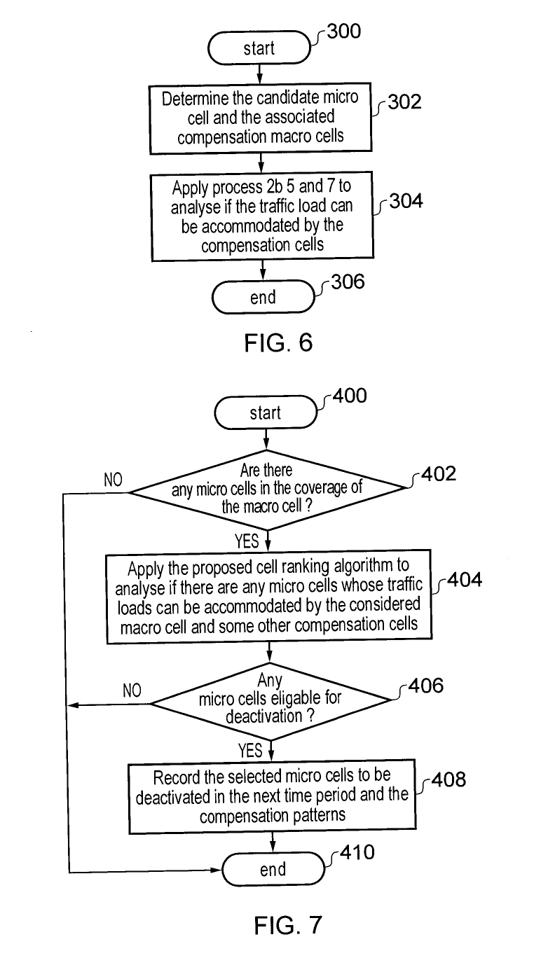

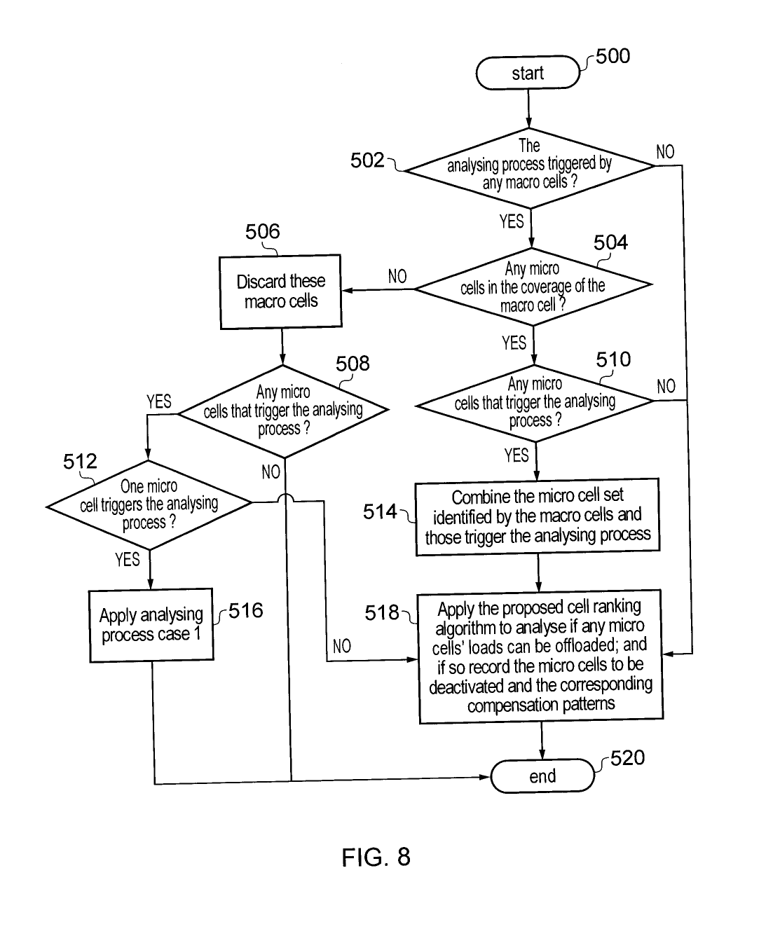

The overall cell ranking algorithm is shown in the flowchart of FIG. 4. The above Cases 1, 2 and 3 correspond to the three analysing processes which appear in the flowchart of FIG. 5. The detailed workflows corresponding to each analysis process are given by FIG. 6, FIG. 7 and FIG. 8 respectively.

Referring to FIGS. 4 and 5, the proposed cell ranking algorithm is described as follows:

Stage 1. After triggering (step 100 in FIG. 4, steps 202 and 204 in FIG. 5) the analyzing process of the SON server, the SON server determines (step 102 in FIG. 4) the candidate micro cells for being deactivated and compiles a list of compensation macro cells for each of the candidate micro cells. This Stage has two aspects as follows:

a. Determination of Candidate Micro Cells:

Case 1: the candidate micro cell is the one that triggers the analyzing process (see steps 206 and 208 in FIG. 5);

Case 2: the candidate micro cells are those under the coverage of the macro cell that triggers the analyzing process (steps 210 and 212 in FIG. 5);

Case 3: the candidate micro cells are those under the coverage of a plurality of macro cells that trigger the analyzing process and those that directly trigger the analyzing process (FIG. 5, step 214).

The results derived from considering one of the above three cases (FIG. 5, step 216) are used as the decisions to determine which micro cells to deactivate in the next time period, and which macro cells to use as compensation cells.

b. Determination of Compensation Macro Cells for Each Candidate Micro Cell (FIG. 4, step 102):

The “compensation macro cell list” may simply be the “neighbour list” of macro cells adjacent a candidate micro cell. If the neighbour list for other purposes is available in the SON server, then the compensation cell list doesn't need to be compiled. If the neighbour list for other purposes is available, but not in the SON server, then the SON server should request it from the network. On the other hand if the neighbour list for other purposes is not available, then the SON server could compile it based on the measurements of users that are in the micro cell.

In the simplified example of FIG. 1, only Cell E has more than one neighbouring macro cell, with the other micro cells overlapping with only a single macro cell; however, real-life heterogeneous networks may be considerably more complex than this.

Stage 2. After triggering the cell ranking algorithm, it is checked (FIG. 4, step 103) whether any (remaining) candidate micro cells exist. If not, (103, “NO”) then the process skips to step 128 described below; otherwise (103, “YES”) the process flow continues to step 104. There, the following cell ranking criteria are comprehensively used to determine the rank (priority for deactivation) of each of the candidate micro cells.

a. Power Efficiency Criterion

i. The power saving gain of a micro cell n is calculated as:

pₑ(n)=p_{consumption}(L(t), n)−p_{idle}(n) (1)

where L(t) represents the traffic load at time t, p_{consumption}(L(t), n) represents the power consumption of cell n with traffic load L(t), p_{idle}(n) is the power consumption of cell n at idle mode.

ii. The power efficiency ranking coefficient Pᵣₐₙₖ(n) is calculated as:

Pᵣₐₙₖ(n)=pₑ(n)/Σᵢ₌₁^{N}pₑ(i) (2)

where N represents the total number of candidate micro cells.

b. Resource Efficiency Criterion (FIG. 4, step 104, 106)

i. The resource efficiency criterion is based on determining how many resource blocks (RBs) of the macro cells are required to fulfil the capacity demand of a micro-cell, which is a candidate for switching off. In some cases, the coverage for the switching off micro cell footprint would be provided by multiple macro cells, with each cell covering a specific region. Here, “region” may refer for example to part of a micro cell's coverage area, and which can be compensated by a specific compensation cell (or sector thereof). In such cases the capacity demand for each region should be predicted. The Holt-Winters method, for example, can be used to predict the capacity demand for each region (or the entire sector) of the micro cell. This method relies on historic data of capacity demand for prediction and it is able to adapt to the time of day variations and upward or downward trends in capacity demand.

Once the capacity demand for the candidate micro cell or each of the regions of the candidate micro cell is predicted, the total number of resource blocks (RB) needed to fulfil that demand must be estimated. If the micro cell footprint can be covered by a single macro cell, the RBs will come from this single macro cell. If the micro cell needs coverage from several macro cells, the total number of RBs required from these macro cells should be considered.

To estimate the number of RBs required, a process similar to cell dimensioning should be undertaken. A wireless communication system such as LTE provides a range of Modulation and Coding Schemes (MCS) which allow a greater or lesser throughput of data depending on the signal-to-noise ratio (SNR) between base station and user. Depending upon the distance from the transmitter of the serving (intended) macro cell, there will be an area (usually in the form of a circle or curvature around the transmitter) where a given SNR (or signal-to-interference and noise, SINR if interference is also considered) range can be achieved.

Usually, only a specific subset of MCS can be supported within this SNR range. The MCS schemes for the entire region to be covered by a specific Macro cell should be identified. Usually higher MCS with greater throughput are applicable to areas closer to the targeted Macro cell. Assuming that users will be uniformly distributed within the region considered (or if the user distribution is known, it can be applied) the demand for each curvature area should be estimated. This should be translated to the number of resource blocks required, by considering the MCS supported in that area. Each MCS has a spectral efficiency value (η) (for example ½ QPSK has η=1 bits/s/Hz) and this determines how many RBs are needed to satisfy the demand. The total RBs is the summation of RBs required for each MCS area. If the micro-cell footprint requires multiple macro cells to compensate, the RB requirement from each of the regions (termed Ni) should be calculated and stored separately.

ii. The resource efficiency ranking coefficient for a particular micro BS is calculated as:

$${R}_{rank} ( n ) = {\sum }_{i = 1}^{K} \frac{{M}_{i}}{{N}_{i}} \qquad ( 3 )$$

where K represents the number of coverage partitions (or compensation macro cells) of the micro cell n based on the layout of its surrounding compensation macro cells, M₁ stands for the total number of available RBs from the i-th macro cell offering partial (or full) coverage to the micro cell n, in other words the number of RBs not already used by the macro cell in serving its existing users. N₁ is the number of RBs required from the ith Macro cell for the partial (or full) coverage compensation. If any of the terms

$$\frac{{N}_{i}}{{M}_{i}}$$

is greater than 1, it means that the micro-cell needs more RBs than the available number of RBs with a covering Macro cell. In the first run of ranking, such micro cells should be excluded, but their ranking should be recorded for the second run, if required. All the candidate micro-cells should be ranked as per eqn (3) and only the micro cells with all the terms

$$\frac{{N}_{i}}{{M}_{i}}$$

being smaller than 1 should be taken to step c, in the first run of ranking.

c. The Weighted Sum of the Power Efficiency and Resource Efficiency Criterion:

cᵣₐₙₖ(n)=α·Pᵣₐₙₖ(n)+β·Rᵣₐₙₖ^{r}(n) (4)

where α, β ∈ [0,1] and α+β=1, and Rᵣₐₙₖ^{r}(n) represents the normalized resource efficiency ranking coefficient, which is calculated as:

Rᵣₐₙₖ^{r}(n)=Rᵣₐₙₖ(n)/Σᵢ₌₁^{N}Rᵣₐₙₖ(i) (5)

Please note that the weighted sum of the power efficiency and resource efficiency criterion can be applied only when the number of candidate micro cells to be deactivated is not zero, i.e. N≧1.

Stage 3. Referring to steps 108 and 114 in FIG. 4, after calculating the priority list of micro cells to be deactivated, if the number of suitable cells to be deactivated is not zero (step 108, “YES”), then the SON server marks (step 114) the cell that has the highest rank to be deactivated first (i.e. with highest priority) in the next time period and the UE allocation pattern and the macro cells used for compensation are based on those calculated in Stage 2b.

Here, the “UE allocation pattern” can be interpreted as the regional traffic load allocation pattern of a micro cell to its compensation macro cells. UEs are not actually assigned to the macro cells at this stage, which is the analysis/estimation carried out at the SON server regarding the regional traffic load of a micro cell that can be taken over by its corresponding compensation macro cells if it is deactivated.

Stage 4. In steps 118, 124 and 125 in FIG. 4, after determining the first micro cell in the priority list to be deactivated, the number of available RBs Mᵢ for the compensating macro cells have to be reduced by the number consumed by the micro cell (step 118). Thereafter, the micro cell to be deactivated is removed from the candidate micro cell list (FIG. 4, step 125), the remaining candidate micro cells are gathered (step 123) and the process flow returns to step 103 so that the algorithm of Stage 2b can be executed again for the remaining micro cells. This step should be repeated in a loop so that successive micro cells are selected for deactivation, until all (or all but a defined safety margin number/percentage) of the available resource blocks run out and all the terms

$$\frac{{N}_{i}}{{M}_{i}}$$

of eqn (3) for all the remaining micro cells are returned as greater than 1.

Stage 5. Referring now to steps 110 and 116 of FIG. 4, if at any point of the algorithm the ranking criterion returns some

$$\frac{{N}_{i}}{{M}_{i}}$$

values (not all) as greater than 1 for all the candidate micro cells, then the micro-cell with the minimum number of

$$\frac{{N}_{i}}{{M}_{i}}$$

values over 1 should be considered for the compensation.

Macro cells where

$$\frac{{N}_{i}}{{M}_{i}} > 1$$

are referred to as “exceeding” macro cells because the demands on them for RBs exceed what is available. In this case it may be possible for other macro cells which have Ni/Mi<1 to make some resources available, in order to bring Ni/Mi down to 1.

For the ith Macro cell where

$$\frac{{N}_{i}}{{M}_{i}} > 1 ,$$

check whether the neighbour macro cell(s) providing coverage have

$$\frac{{N}_{i}}{{M}_{i}} < 1.$$

If so, further check whether the following inequality is valid:

Σᵢ₌₁^{K′}(Nᵢ−Mᵢ)≦Σ_{q=1}^{Q}RB_{available}(q) (6)

where K′ represents the number of macro cells with

$$\frac{{N}_{i}}{{M}_{i}} > 1 ,$$

Q stands for the number of compensation macro cells of micro cell n with

$$\frac{{N}_{i}}{{M}_{i}} < 1 ,$$

and RB_{available}(q) is the number of extra RBs that can be offered to support the exceeding macro cells' capacity demands. If so, redraw this neighbour cell boundary using the load balancing techniques, so that this neighbour macro cell(s) can support more of the capacity demand and bring the

$$\frac{{N}_{i}}{{M}_{i}}$$

ratio for the exceeding Macro cell to 1 or below 1 in running the dimensioning process illustrated in Stage 2b.

The above analysis is carried out at the SON server, and it is just a conceptual redrawing rather than a change in cell boundaries by the eNodeBs. The boundary redrawing is mainly applied to cell edge users, and does not necessarily require that the cell coverages overlap with each other, so long as there is some overlap at cell edge. In practice, the redrawing of boundaries can be realized through the load balancing mechanism, for example, cell edge UEs of a heavily loaded cell can be configured to be handed over to its neighbouring cell with low traffic. Even though the neighbouring cell may not be the cell edge UEs' best serving cell, it may be second/third best cell which can be used for data transmission with lower SNR (or SINR).

If this step is not successful (step 120, “NO”), remove the case B micro cells from the candidate micro cell list (step 122) and update the candidate micro cell list (step 123) prior to repeating the process (step 103) as there are no newly-selected micro cells to be marked for deactivation. On the other hand if this step is successful (step 120, “YES”), return the micro cells that succeed in the compensation cell boundary adjustment process (step 126), then follow steps 114, 118, 124 and 125 as for Case A, including ranking the cells as in Stage 2c (step 114) and marking for deactivation the micro cells with the highest rank (step 124).

Here in order to make this re-adjustment step successful, one additional aggressive step can be applied to make more RBs available from the macro cells with

$$\frac{{N}_{i}}{{M}_{i}} < 1 ,$$

which is that for each of the macro cells (e.g. macro cell x) with

$$\frac{{N}_{i}}{{M}_{i}} < 1 ,$$

check its neighbour macro cell(s)' traffic loads (excluding those neighbours that are already involved in the compensation of the micro cell), and if there are extra RBs available from them then apply a load balancing method to change their cell boundaries to help offload the cell edge traffic of macro cell x, and apply cell dimensioning method to calculate the new traffic load at macro cell x. After applying this process to each of the macro cells with

$$\frac{{N}_{i}}{{M}_{i}} < 1 ,$$

the final number of RBs available from the neighbour macro cells (with

$$\frac{{N}_{i}}{{M}_{i}} < 1 )$$

of the exceeding macro cell (with

$$\frac{{N}_{i}}{{M}_{i}} > 1 )$$

can be calculated.

Otherwise, the micro cell n is considered not to be deactivated in the next time period without performing Stage 2c.

Stage 6. As already mentioned with respect to step 126 in FIG. 4, the procedure described above at Stage 5 is repeated with re-adjustment of macro cell boundaries in dimensioning, so that available RBs are exhausted in the macro cells and all the terms

$$\frac{{N}_{i}}{{M}_{i}}$$

of eqn (3) for all the remaining micro cells are returned as greater than 1.

Stage 7. Returning to the cases of step 112, “YES” and step 120, “NO”, the flow proceeds to step 122 in FIG. 4. Thus, if at any point of the algorithm the ranking criterion returns all

$$\frac{{N}_{i}}{{M}_{i}}$$

values as greater than 1 for a candidate micro cell; or if the ranking criterion returns some

$$\frac{{N}_{i}}{{M}_{i}}$$

values (not all) as greater than 1 for a candidate micro cell, and for the ith Macro cell where

$$\frac{{N}_{i}}{{M}_{i}} > 1 ,$$

if there are neighbour macro cell(s) providing coverage with

$$\frac{{N}_{i}}{{M}_{i}} < 1$$

but after redrawing the neighbour cell boundary the neighbour macro cell(s) are not able to bring the

$$\frac{{N}_{i}}{{M}_{i}}$$

ratio for the exceeding Macro cell to 1 or below 1 in running the Stage 2b, then the micro cell n is excluded from the list, in other words it is considered not to be deactivated in the next time period without performing Stage 2c, and the process returns to step 103 via step 123 to consider the remaining candidates if any.

Stage 8. When there are no, or no remaining, candidate micro cells (step 103, “NO), the cell ranking procedure us completed in step 128, by the SON server instructing the compensation cell eNodeBs to take over the traffic of the micro cells marked for deactivation, and instructing the relevant eNodeBs to enable those micro cells to enter the sleep mode. The process then terminates at step 130.

One additional checking step may be done before sending the instructions in order to avoid ping pong. For example, the SON server may store and refer to the cell status information over the preceding few time periods, and if the cell's status has not been changed for a certain number of time periods, then the cell status can be updated for the next time period, otherwise the cell status stays the same as before. Thus a hysteresis is incorporated in the mechanism to avoid frequent cell status change.

Stage 9. The network operates with the macro and micro cells so configured until expiry of the predetermined time period, e.g. 15 minutes, after which the procedure may be repeated. In this way, the SON server can carry out the On/Off analysis at a fixed time interval. After the analysis, if a cell is in the Off cell list, then the cell should be deactivated for the next time period; but if it is not in the Off cell list, then it means it is decided to be “On” for the next time period. Therefore, using the proposed method not only are the deactivation decisions made, but also the activation decisions are implicitly made.

Thus, after each time interval, the investigation area's traffic distribution is re-evaluated. As already mentioned, the SON server may generate a traffic map for the investigation area, using which the cell load of all macro and micro cells can be predicted (even if some micro cells may be “Off”, the prediction can be based on their coverage footprint information). Based on the predicted cell load information, the candidate micro cells for the ranking algorithm can be worked out; if a micro cell is put in an “Off” cell list, then it will be deactivated in the next time period, checking its current status, if it is already “Off”, then its status will remain “Off”, otherwise its status needs to be updated; if a micro cell is not in the “Off” cell list, that means it will be “On” during the next time period, and again its current status needs to be checked to see whether its status requires an update or not.

The traffic distribution information can be made available in different ways. If the algorithm is applied to historical data stored by the operator in order to diagnose the network's potential for energy saving, then the traffic distribution information can be obtained from the historical data; if the algorithm is used in the live network at the SON server to control the cell's status, then the predicted traffic map is obtained from using the current measured traffic load of cells and some existing prediction methods.

FIG. 6 illustrates Case 1 referred to above. The process starts in step 300. In step 302, it is determined which micro cell is candidate to offload their traffic onto one or more compensation macro cells. Then (step 304) it is checked whether the resources offered by the compensation macro cells are sufficient to accommodate the entire load of the micro cell, such as to allow the latter to be deactivated. The process then ends (step 306).

FIG. 7 summarises the process performed in Case 2. If the analyzing process is triggered (step 400) by one macro cell whose traffic load is lower than the threshold, then the SON server checks (step 402) if there are any micro cells that are under the coverage of this low load macro cell or any other macro cell (step 404). If not (step 402, “NO”), the process ends (step 410). If there are such micro cells, (step 402, “YES”) it is then checked (step 406) whether any micro cells have been identified which are suitable for deactivation. If not (step 406, “NO”) the process returns to step 402. If there are such micro cells (step 406, “YES”), the process calculates the priority lists of micro cells to be deactivated and analyzes whose traffic loads can be accommodated by the macro cell and records these cells (step 408); the process then ends (410).

In Case 3, illustrated in FIG. 8, the process starts at step 500. If the analyzing process is triggered (step 502, “YES”) by any macro cells whose traffic loads are lower than the threshold, then it is checked (step 504) whether there are any micro cells in the coverage area of the macro cells concerned. If not (step 504, “NO”) then the macro cells concerned are discarded (step 506). If there are such macro cells (step 504, “YES”), the SON server checks whether there are other micro cells which trigger the analysis process referred to earlier (step 510). If not (step 510, “NO”) the cell ranking algorithm is applied to only the micro cells found in step 504; conversely if there are such other micro cells (step 510, “YES”), these are added in (step 514) prior to performing the cell ranking algorithm. Thus, the SON server calculates the priority lists of micro cells to be deactivated and analyzes which ones can be turned to sleep mode in the next time period and what the corresponding compensation patterns are. Likewise, following step 506 it is checked (step 508) whether there are other micro cells which trigger the analysis process. If not (step 508, “NO”) the process ends (520). If there are one or more such micro cells, then if there is only one such cell (step 512, “YES”) then Case 1 above applies (516) and the process ends (520). Otherwise (in other words when there are multiple micro cell candidates), the cell ranking algorithm is again applied in step 518.

With respect to the above procedure, the following points should be noted.

(i) In Stage 1 of the cell ranking algorithm, the trigger of the analyzing process is based on the traffic profile, in other words the traffic loads of cells monitored by the SON server at the current time period. Here, “time period” may be any convenient time period for which the results of the process should be applied, and after which the process should, or may, be repeated. This “time period” is configurable. It can be scaled from minutes to hours. However, a shorter time period can cause signalling burden to the network, and currently (in LTE) the network can support 15 mins as the time interval for reporting traffic load for the load balancing purposes.

The traffic profile can be obtained in different ways, depending on the application scenario of the proposed technique. If for example the algorithm is applied to historical data stored by the operator in order to diagnose the network's potential for energy saving, then the temporal traffic profile like FIG. 2 can be extracted from the historical data; if the algorithm is used in the live network at the SON server to control the cell's status, there are existing prediction methods such as the Holt-Winters method that can be used to predict the next time period's traffic load based on the previously measured traffic loads.

(ii) In Stage 2a, the traffic load L(t) used in equation (1) represents the predicted traffic load during the next time period, thereby the power saving gain is calculated based on the traffic load in the next time period.

(iii) In Stage 2b, the user allocation to compensation cells is based on the traffic load predictions of the micro and macro cells at the next time period, i.e. to use the traffic load prediction of the considered micro cell as the set of UEs that need to be allocated and that of the compensation macro cells to work out the extra RBs available to accommodate the traffic loads of deactivated micro cells. The more accurate the traffic load predictions are, the better QoS can be provided to the UEs after the deactivation of micro cells.

(iv) In order to work out the available RBs from the compensation macro cell(s) to a given micro cell, if there is re-activation process of any micro cell triggered, then it is assumed that the re-activation decision is made first before performing the analysing process for the deactivation of micro cells. Thereby potentially the re-activated micro cells can help offload some of the macro cell's traffic, and the calculation on how many extra RBs are available for the next time period to the potentially deactivated micro cell is more accurate.

The advantages of the proposed algorithm include that:

(a) the energy saving gain is not obtained at the price of sacrificing the UE experience in terms of data transmission rate, since before deactivation of micro cells analysis is carried out to ensure the traffic load can be accommodated and QoS can be maintained by the compensation cells through ensuring that RBs are allocated sufficient to meet the users' needs;

(b) it deactivates micro cells that have less power efficiency (i.e. more power saving by being deactivated) and require fewer resources to compensate, thus the power saving gain is maximized by reducing the compensation costs in terms of frequency resources;

(c) the proposed algorithm for traffic load allocation to compensation cells is based on traffic load predictions of micro and macro cells, and furthermore based on regional traffic load predictions of a micro cell, therefore the analysis is more accurate, and the deactivation decision made can be valid for longer time period. That is, the proposed algorithm relies on traffic load predictions of the next time period when doing the deactivation analysis, not the traffic load information of the current time period, therefore the on/off decisions made should be more accurate and valid for the next time period rather than being only valid for a short time period after the current time period as would be the case if the analysis were based on the current measured traffic load information. The validity time period of the decisions is also related to that of the traffic load predictions, i.e. the longer period the traffic load prediction is for, the longer the validity period of the decisions is.

Various modifications are possible within the scope of the present invention.

Reference has been made above to “macro” and “micro” cells, but embodiments of the present invention can be applied to heterogeneous networks having any kinds of cell including pico, femto and so on, and to any number of levels of cell.

The embodiment described above does not consider the case where macro cells are deactivated during low traffic periods, because it is assumed that the basic coverage of the network is provided by all of the macro cells, with the micro cells used in certain areas for capacity boosting purposes. If under some circumstances where operators wished to use lots of micro cells to provide the basic coverage, and macro cells to meet the additional capacity requirement, then it would be possible to use the ranking algorithm of the invention to decide the priority of deactivating macro cells.

The above-mentioned embodiment assumes that all the cells are 4G (e.g. LTE). It is not necessary, however, for the macro and micro cells to use the same RAT. The RAT for each of them could be any kind, for example, 3G or 4G. However the proposed algorithm is intended to be used for the planned network in which all cells are under supervision of a common supervising entity such as a SON server.

Normally both the macro and micro eNodeBs are owned by a telecoms operator. The proposed algorithm is therefore effective for reducing the operator network's power consumption. If all or some micro cells were installed by users, then the present invention would be effective for reducing the combined power consumption of the operator-installed and user-installed equipment.

To summarise, embodiments of the present invention may provide a cell ranking algorithm in order to determine when and which micro cells in the cellular wireless network can be deactivated, by which the power consumption of the network can be reduced without sacrificing QoS of users. The proposed algorithm is based on the comprehensive consideration of factors that have influence on the power saving of the network and the balance between the traffic load (or quality of service) and the energy saving.

### INDUSTRIAL APPLICABILITY

Nowadays one of the major worldwide concern is the increasing energy consumption and its effect on the environment. The global information and communication technology (ICT) industry is a fast growing contributor to the world wide greenhouse gas emissions, by 2008 figures, it was estimated that 3 percent of worldwide energy consumption was caused by the ICT infrastructure that generated about 2 percent of the worldwide CO2 emissions. The algorithm presented in this invention provides a way to enable the micro cells to be deactivated during off-peak hours while satisfying the requirements of user equipments (UEs) on the data transmission rates. Thus the energy wasting is reduced and energy efficiency is improved for the wireless networks.

1. A method of managing power consumption in a heterogeneous network providing cells for wireless communication, the network including basic coverage cells overlapping with additional capacity cells, the method comprising:
(i) determining traffic loads on the basic coverage cells and additional capacity cells;
(ii) triggering an analysis process when the load on at least one cell meets a threshold condition;
(iii) if an additional capacity cell meets the threshold condition, seeking one or more basic coverage cells as a compensation cell to take over the load on that additional capacity cell; and/or
(iv) if a basic coverage cell meets the threshold condition, seeking at least one additional capacity cell from which the basic coverage cell can take over the load as a compensation cell;
(v) marking for deactivation a additional capacity cell considered in step (iii) and for which at least one compensation cell has been found and/or marking for deactivation an additional capacity cell found in step (iv), and
(vi) deactivating any additional capacity cell marked for deactivation and instructing at least one compensation cell to take over the load from the additional capacity cell.

2. The method according to claim 1 wherein step (i) includes collecting current cell load information of active basic coverage and additional capacity cells, analysing the collected information to generate the predicted traffic map in an investigation area of the network, and estimating the traffic load on each of the cells in the investigation area.

3. The method according to claim 1 wherein step (ii) includes triggering an analysis process based on the predicted cell load of cells in the investigation area.

4. The method according to claim 1 wherein step (iii) comprises obtaining a list of basic coverage cells for possible use as compensation cells.

5. The method according to claim 1 wherein step (iii) and/or (iv) comprises or is followed by compiling a prioritized list of additional capacity cells, and step (v) comprises marking for deactivation at least one additional capacity cell on the basis of the prioritized list.

6. The method according to claim 5 wherein the prioritized list ranks candidate additional capacity cells based at least partly on a power saving gain.

7. The method according to claim 6 wherein the prioritized list ranks candidate additional capacity cells based at least partly on a resource efficiency criterion.

8. The method according to claim 5 wherein the prioritized list ranks candidate additional capacity cells based on a weighted sum of a power saving gain and a resource efficiency criterion.

9. The method according to claim 6 wherein the power saving gain is determined by calculating a difference between a power consumption for operating the additional capacity cell and a power consumption with the additional capacity cell deactivated.

10. The method according to claim 7 wherein the resource efficiency criterion quantifies basic coverage cell resources offered to take over the load on the additional capacity cell relative to basic coverage cell resources required to meet the additional capacity cell's load.

11. The method according to claim 10 wherein the required basic coverage cell resources are estimated based on long-term SNR/SINR distributions provided by transmitters of one or more basic coverage cells to one or more regions covered by the additional capacity cell.

12. The method according to claim 5 wherein after marking a additional capacity cell for deactivation in step (v), the prioritized list is recompiled taking into account the effect on one or more compensation cells of taking over the additional capacity cell's load.

13. The method according to claim 7 further comprising determining a resource efficiency criterion for the basic coverage cells and redistributing load among basic coverage cells to avoid overloading a compensation cell.

14. The method according to claim 1 wherein the threshold condition is met when a current traffic load or a predicted traffic load on a cell falls below a threshold value.

15. The method according to claim 9 wherein the power consumption for operating the additional capacity cell is determined by predicting a future traffic load on the cell.

16. The method according to claim 10 wherein the basic coverage cell resources are determined by predicting a future traffic load on the cell.

17. The method according to claim 1 wherein the deactivation remains valid for a predetermined time interval, after which the method is repeated to permit reactivation of a deactivated additional capacity cell.

18. The method according to claim 1 applied to a self-organizing network, SON, wherein the method is carried out by a SON server of the network.

19. A SON server arranged to carry out the method of claim 1.
